(19) United States
(12) Patent Application Publication
(10) Pub. No.: US 2026/0320377 A1
(43) Pub. Date: Oct. 15, 2026

(54) UNMASKED LANGUAGE MODEL TRAINING USING ANTI-MODELING

(71) Applicant: Oracle International Corporation, Redwood Shores, CA (US)

(72) Inventors: Michael Louis Wick, Lexington, MA (US); Adam Craig Pocock, Burlington, MA (US); Katherine Silverstein, Somerville, MA (US)

(73) Assignee: Oracle International Corporation, Redwood Shores, CA (US)

(21) Appl. No.: 19/176,154

(22) Filed: Apr. 11, 2025

(51) Int. Cl. G06N 3/08; G06N 3/045

(52) U.S. Cl. CPC G06N 3/08; G06N 3/045

(57) ABSTRACT

Training large language models using masked language modeling is computationally expensive and data inefficient, as it requires multiple forward passes to learn from individual masked tokens in a sequence. A method for training language models is introduced using unmasked positive data and permuted negative data to address these limitations. Positive data includes grammatical, well-formed sequences, while negative data includes randomly or validated permuted versions of the positive data, designed to disrupt linguistic structure. The method trains the model to assign high probabilities to positive data and low probabilities to negative data, using anti-modeling techniques to prevent the model from adopting undesirable shortcuts, such as copying input tokens. This approach enables the language model to learn meaningful linguistic representations in fewer forward passes, significantly improving data and computational efficiency while maintaining robust generalization capabilities.

### BACKGROUND

Language modeling is becoming a central task in natural language processing. While formal languages used in computer programming can be fully specified, this is not possible with natural language. Words and syntax can be rigidly defined in programming languages. Words, usage, and syntax in natural languages evolve over time and involve a very large number of ambiguous rules and meanings. Language modeling is the development of probabilistic models that are able to predict subsequent text based on a number of proceeding words. These language models learn their behavior by training on natural language text.

Language models may be used to evaluate tasks performed by speech recognition, character recognition, and other translations from natural language to a digital representation. For example, audio data may be used as an input to a speech recognition process. Audio data may be interpreted by a speech-recognition algorithm, and each word in the audio stream may be recognized using the language model such that it falls within the context of words that have previously been recognized. Language models may also be used to generate text in applications such as handwriting recognition, machine translation, spelling correction, autocomplete fields, image captioning, text summarization, and so forth. More powerful language models also can learn representations—sometimes called embeddings—of characters, words, phrases and sequences thereof. These representations can be used as features for downstream natural language processing tasks like named entity recognition (NER) or document classification.

Recently, the use of neural language modeling (NLM) has become the preferred model type for these applications. Neural network approaches are achieving better results than classical methods in almost every aspect. Neural language models overcome the shortcomings of traditional language models by training on increasingly large context sizes to recognize long-distance dependencies in text strings. Neural models also generalize words beyond a single instance to include parts of speech and other contexts.

Training language models requires a large corpus of positive input text. The parameters for the language models are derived such that the language model is likely to predict the strings provided within the training corpus. However, while this maximizes the ability of the language model to predict positive, grammatical, well-formed text strings, it leaves the language model susceptible to negative signals. These negative signals may be embodied in the trained language model such that they not only accurately predict positive text, but they may also be susceptible to generating relatively low perplexity scores for ungrammatical text. Therefore, improvement in the art is needed.

### BRIEF SUMMARY

In some embodiments, a method for training language models may include providing a sequence of tokens representing positive training data; permuting the sequence of tokens to represent negative training data; and training a language model using the positive training data and the negative training data, where training the language model may include adjusting parameters of the language model to increase a probability associated with the positive training data and to decrease a probability associated with the negative training data.

In some embodiments, a non-transitory computer-readable medium may include instructions that, when executed by one or more processors, cause the one or more processors to perform operations including providing a sequence of tokens representing positive training data; permuting the sequence of tokens to represent negative training data; and training a language model using the positive training data and the negative training data, where training the language model may include adjusting parameters of the language model to increase a probability associated with the positive training data and to decrease a probability associated with the negative training data.

In some embodiments, a system may include one or more processors and one or more memory devices including instructions that, when executed by the one or more processors, cause the one or more processors to perform operations including providing a sequence of tokens representing positive training data; permuting the sequence of tokens to represent negative training data; and training a language model using the positive training data and the negative training data, where training the language model may include adjusting parameters of the language model to increase a probability associated with the positive training data and to decrease a probability associated with the negative training data.

In any embodiments, any or all of the following features may be implemented in any combination and without limitation. Training the language model may include using a likelihood function, where the likelihood function may maximize a probability of the language model predicting the positive training data. The likelihood function may also minimize a probability of the language model predicting the negative training data. Minimizing the probability of the language model predicting the negative training data may include maximizing 1 minus the probability of the language model predicting the negative training data. The likelihood function may optimize a plurality of weights. The negative training data may include a permutation of the positive training data, the permutation being a rearrangement of tokens within the positive training data. The permutation may be random, such that the tokens of the positive training data are randomly rearranged to form the negative training data. The permutation may be validated to ensure that no substrings of the positive training data remain intact in the negative training data. The negative training data may be generated by tokenizing the positive training data into n-grams, and the n-grams are permuted to form the negative training data. The negative training data may be generated using an anti-model, where the anti-model may be trained to generate un-grammatical features based on the positive training data. Training iterations may be performed, where each of the training iterations may include providing a unique permutation of the positive training data as the negative training data. Training the language model may include using a single forward pass to process both the positive training data and the negative training data together. The positive training data may be obtained from publicly available corpora. The language model may include a neural language model or a masked model. The language model may include a Bidirectional Encoder Representations from Transformers model. The negative training data may be generated by applying random permutations to sentences in the positive training data, and the negative training data may be verified to not resemble natural language constructs. The negative training data may be a same length as the positive training data, and tokens in the negative training data may all be found in the positive training data. Training the language model may include using stochastic gradient descent to iteratively adjust internal parameters of the language model based on the positive training data and the negative training data.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates how a language model 102 can be trained using masked inputs, according to some embodiments.

FIG. 2 illustrates a method for training language models, according to some embodiments.

FIGS. 3A-3B illustrate two individual training input pairs that may be provided to the language model, according to some embodiments.

FIG. 4 illustrates a simplified block diagram of a distributed system for implementing some of the embodiments.

FIG. 5 illustrates a simplified block diagram of components of a system environment by which services provided by the components of an embodiment system may be offered as cloud services.

FIG. 6 illustrates an exemplary computer system, in which various embodiments may be implemented.

### DETAILED DESCRIPTION

Training large language models using masked language modeling is computationally expensive and data inefficient, as it requires multiple forward passes to learn from individual masked tokens in a sequence. A method for training language models is introduced using unmasked positive data and permuted negative data to address these limitations. Positive data includes grammatical, well-formed sequences, while negative data includes randomly or validated permuted versions of the positive data, designed to disrupt linguistic structure. The method trains the model to assign high probabilities to positive data and low probabilities to negative data, using anti-modeling techniques to prevent the model from adopting undesirable shortcuts, such as copying input tokens. This approach enables the language model to learn meaningful linguistic representations in fewer forward passes, significantly improving data and computational efficiency while maintaining robust generalization capabilities.

Training large language models to understand and predict human language has become a cornerstone of advancements in natural language processing (NLP). Modern language models are typically trained using vast corpora of text that represent linguistic patterns, syntactic structures, and semantic relationships. One approach for training these models involves the use of masked language modeling techniques. This process challenges the model to predict missing or “masked” words within a sentence based on the surrounding context, thereby enhancing its ability to learn meaningful representations of language.

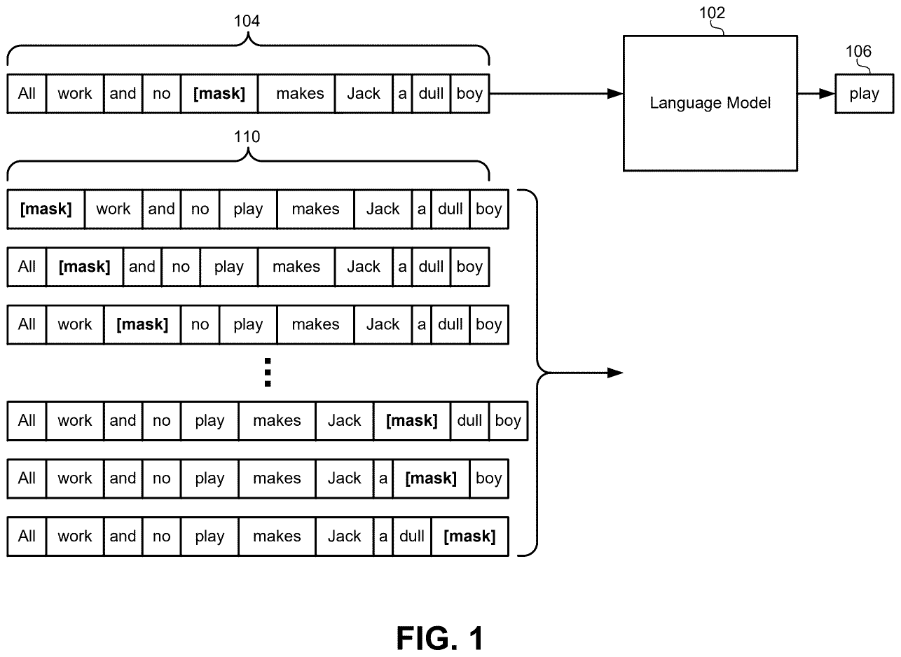

FIG. 1 illustrates how a language model 102 can be trained using masked inputs, according to some embodiments. Masked language modeling introduces a unique training paradigm where words or tokens in a given sentence are randomly selected for masking. During training, these masked tokens are replaced with placeholders, and the model is tasked with predicting the masked word or token. For example, an input 104 such as “all work and no [mask] makes Jack a dull boy,” might be presented to the language model 102 during training, with the language model 102 predicting an output 106 that the masked token is “play.” This approach leverages the natural redundancy and contextual clues inherent in human language, enabling the language model 102 to infer missing information and learn complex dependencies between words.

The language model 102 may be trained by evaluating the probability of accurately predicting the correct word that has been replaced by the mask. In this process, the correct word serves as the label for the training data, providing a benchmark against which predictions of the language model 102 are measured. During training, the language model 102 receives a sequence containing one or more masked tokens and generates an output prediction for the masked position. The probability that the predicted word matches the correct word is calculated using a likelihood function. This loss function quantifies the difference between the model's predicted probabilities and the actual label. The internal weights of the language model 102 may then be adjusted iteratively using optimization techniques to minimize the loss and increase the probability that the output 106 aligns with the correct word. This process may also decrease the probability of the incorrect word being predicted by the language model 102. Through repeated exposure to masked training data and continuous weight adjustment, the language model 102 learns to predict masked tokens with higher accuracy and refines its ability to understand linguistic context and dependencies.

The process of masking provides several advantages in training language models. First, it encourages the model to focus on the relationships between words, rather than relying solely on superficial patterns or co-occurrence statistics. By predicting masked words based on surrounding tokens, the model develops a deeper understanding of syntax, semantics, and word associations. Second, masking introduces a form of data augmentation, increasing the diversity of training inputs without requiring additional data. Randomly selecting words for masking ensures that the model encounters a wide variety of linguistic contexts, further enriching its training experience. Masked language modeling techniques have proven particularly effective in transformer-based architectures, such as Bidirectional Encoder Representations from Transformers (BERT) and its derivatives. These models utilize bidirectional attention mechanisms, enabling them to consider the entire context of a sentence-both preceding and succeeding tokens-when predicting masked words. Masked language modeling enables the language model 102 to effectively identify intent within a sentence by training it to understand the underlying context and semantic relationships between words. By predicting masked tokens based on surrounding text, the model develops a nuanced understanding of how individual words contribute to the meaning and purpose of a sentence. For interactive user queries, such as those in a chatbot environment, this ability to infer intent is crucial for providing accurate and relevant responses. For example, in a query like, “Can you ______ me the nearest coffee shop?” the model can predict that the masked word is likely “find” or “show” based on the surrounding context, thereby interpreting the user's request to locate a coffee shop. This contextual awareness, developed through masked language modeling, allows the language model 102 to discern user intent even when queries are incomplete, ambiguous, or phrased differently, making it invaluable for real-time conversational applications and enhancing user interaction experiences.

Despite the success of masked language modeling techniques, existing approaches face certain limitations. Language models utilize a masking strategy to randomly hide a subset of tokens within a sequence and train the model to predict the masked words based on surrounding context. While effective, this approach is computationally expensive due to the quadratic complexity inherent in the transformer-based architecture's forward pass over the sequence length. Furthermore, masking only a small subset of tokens in each training iteration limits the data efficiency, as the model learns exclusively from the masked tokens, leaving significant training potential untapped. For example, in a sentence such as “All work and no play makes Jack a dull boy” as an input 104, masking and predicting the word “play” provides only a single learning instance for the model during that forward pass. To learn from all tokens in the sequence, the masking process would need to be repeated for each individual token, requiring a separate forward pass for each iteration, thereby increasing the computational cost exponentially to cubic complexity. This technical bottleneck results in extreme data inefficiency and computational overhead, leaving substantial opportunities for improving training methodologies unaddressed.

For example, FIG. 1 illustrates how if the language model 102 is to learn from more tokens in the sentence, then the input 104 may need to change which words are masked, and then re-run the forward pass from scratch each time. In the extreme case of only masking a single token (or constant number of tokens), this would require running O(n) forward passes to learn from all the tokens in the data, making the cost of the masked language model cubic in sequence length rather than quadratic. In this example, each word in the input 110 may be sequentially or randomly masked in the sentence and analyzed, one-at-a-time by the language model 102 to predict the missing word.

While removing masks entirely might allow the model to learn from all tokens in a single forward pass, this approach introduces the risk of the model “cheating” by simply copying the input tokens to the output, rather than learning meaningful contextual embeddings. For example, permutations of the input 114 (e.g., shuffling the order of the words in the input 114) may simply train the model to generate the same output from the input, which is not very useful for the purpose of learning contextual embeddings for fine-tuning.

To solve these and other technical problems, some embodiments described herein train the language model 102 using a dual strategy that combines unmasked positive data with grammatically incorrect negative data to create a robust learning process. Positive data, which generally includes well-formed and grammatical sentences, is used to train the model to assign high likelihoods to correct predictions, ensuring that it learns to generate accurate and contextually appropriate outputs. Simultaneously, the process incorporates anti-modeling techniques to train the language model 102 using negative data—such as positive sentences with randomly permuted tokens or other ungrammatical constructs—forcing the language model 102 to assign low likelihoods to these inputs. This approach addresses a key challenge in unmasked language modeling: preventing the model from “cheating” by simply copying input tokens to the output without understanding the underlying linguistic structures. By incorporating anti-modeling, this process ensures that a model which learns to “cheat” will inadvertently generalize to negative data, assigning high likelihoods to sequences that do not resemble natural language. Anti-modeling counteracts this by penalizing the model for assigning high likelihoods to negative data, effectively preventing it from adopting this shortcut. As a result, the language model 102 is guided to learn meaningful representations of language that generalize correctly to both positive and negative inputs, avoiding the pitfalls of data inefficiency and inappropriate generalization.

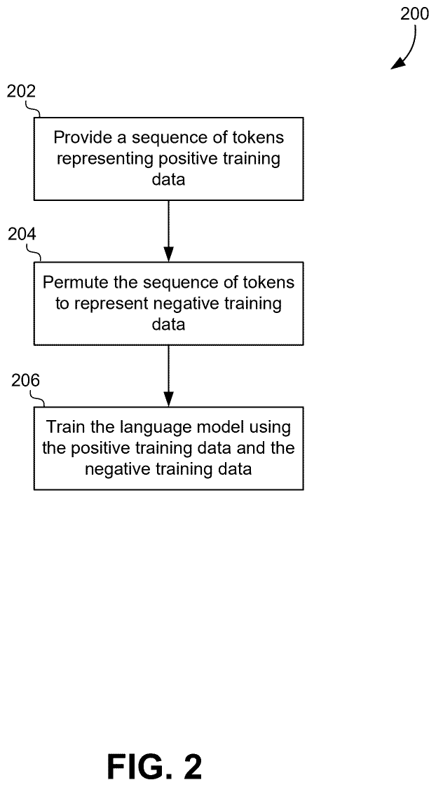

FIG. 2 illustrates a method for training language models, according to some embodiments. The method may include providing a sequence of tokens representing positive training data (202). Positive training data refers to a set of text inputs that are considered grammatical, well-formed, and representative of natural language constructs. This data serves as the foundation for training a language model to recognize and predict linguistically accurate sequences. Positive training data may be derived from a variety of sources, including publicly available text corpora, curated datasets, or other collections of human-generated text. Examples of widely used online training corpora include the Common Crawl dataset, Wikipedia dumps, OpenWebText, Project Gutenberg texts, and datasets provided by organizations such as the Linguistic Data Consortium (LDC). Additionally, pre-trained language models that have been trained on high-quality corpora to generate or predict grammatical text may also be utilized as a source of positive training data.

The language model may be a masked language model, which is a type of machine-learning model designed to predict missing or “masked” words within a sequence of text based on the surrounding context. As described above, during training, specific words or tokens in an input sentence are randomly replaced with a placeholder, and the model learns to infer the identity of the masked tokens by analyzing their relationships with the unmasked tokens. This training technique encourages the model to develop a deep understanding of linguistic patterns, syntactic structures, and semantic relationships, enabling it to generate accurate predictions and meaningful contextual embeddings for tasks such as natural language processing, text generation, and understanding user queries. For example, masked language models may include models similar to the Bidirectional Encoder Representations from Transformers (BERT) model, which uses bidirectional attention to consider both preceding and succeeding tokens in a sequence when predicting masked words. Many different variations of the BERT model are also compatible with these techniques.

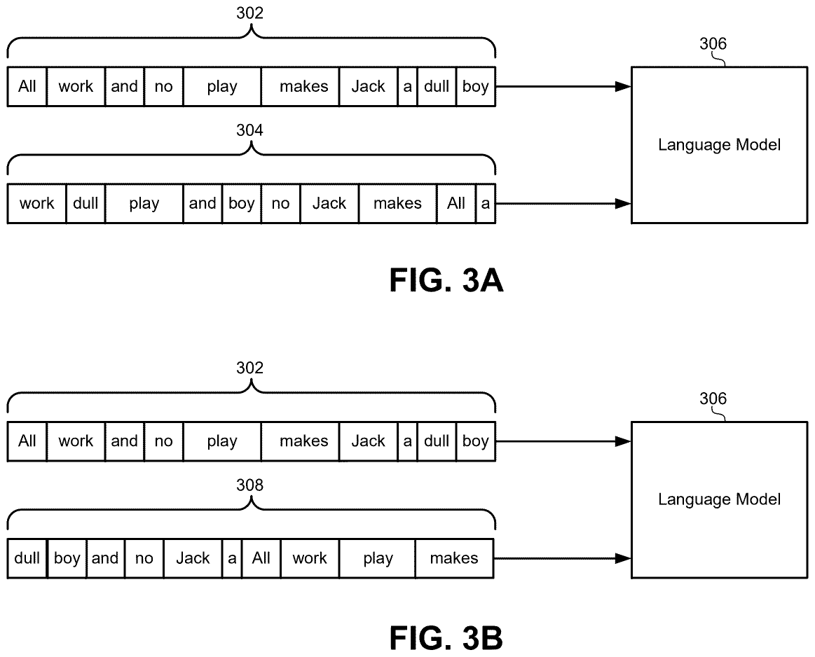

FIG. 3A illustrates a diagram of inputs for training language models, according to some embodiments. The corpora described above may be used to select a sequence of tokens that represent positive data. For example, the sequence of tokens may be a sentence, paragraph, or some other logical block of text. The positive training data 302 in this example is a single English sentence: “All work and no play makes Jack a dull boy.” However, larger multi-sentence inputs may also be used, as well as shorter clauses, to train the language model to recognize varying linguistic contexts and structures.

Unlike traditional masked language models that rely on masking specific terms in the training data, the positive training data 302 used by the language model 306 need not include any masked terms. Instead, the language model 306 employs a classifier for each word in the input sequence, enabling it to maximize the probability of predicting each word simultaneously. These classifiers are designed to operate independently yet concurrently, allowing the training forward pass to process the entire sequence of positive training data 302 at once, rather than sequentially masking individual words. In this approach, each word in the input sequence is treated as a separate classification task, with the corresponding classifier predicting the likelihood of that word being correct based on the surrounding context. The classifiers operate within the layers of the language model 306, leveraging the model's learned embeddings and contextual representations to assign probabilities to each word. For instance, if the positive training data 302 includes the sentence “All work and no play makes Jack a dull boy,” each word in the sequence—such as “All,” “work,” and “play”—may be associated with a classifier that evaluates the probability of that word being correct in its respective position.

Using this unmasked technique, the language model 306 can analyze the entire sequence of positive training data 302 in a single forward pass, effectively replicating the outcome of individually masking each word and processing the sequence multiple times. For example, instead of performing 10 individual forward passes for a sentence with 10 words (each time masking a different word), the model processes the entire sequence in one forward pass. This approach not only accelerates the training process but also ensures that the model learns from all words in the sequence simultaneously, rather than focusing on one masked word at a time. This simultaneous processing enhances data efficiency, as the model extracts contextual relationships and dependencies between words.

As described above, the potential downside of using unmasked data is that the language model 306 may be trained to “cheat” by simply copying the input word to the output without genuinely understanding the surrounding context. This occurs when the model learns to maximize probabilities for each word based solely on its position in the sequence rather than relying on the linguistic relationships and dependencies between words. As a result, instead of capturing meaningful contextual representations, the model may default to memorizing the input-output mapping, which undermines its ability to generalize to unseen data or handle complex language tasks. This limitation highlights the importance of incorporating additional techniques, such as anti-modeling with negative data, to prevent the model from adopting such shortcuts and ensure it develops a deeper understanding of language structure and semantics.

The method 200 may also include permuting the sequence of tokens to represent negative training data (204). The goal of the unmasked language model is to learn a hypothesis similar to what a masked language model would learn when trained on the same text data, ensuring that the model does not “cheat” by simply copying input tokens to the output. To achieve this, the method 200 may incorporate an anti-modeling approach that introduces negative data into the training process. This negative data may be designed to (a) prevent the model from adopting the identity function as a shortcut for predicting outputs and (b) ensure that the model's ability to learn from positive text data remains unaffected.

Satisfying the first condition (a) is straightforward: any model that learns to cheat by adopting the identity function will exhibit perfect performance on all datasets, including nonsensical inputs such as gibberish or randomly generated sequences. This is because the identity function bypasses the need to analyze linguistic structure or contextual relationships, simply replicating the input tokens as the output. The second condition (b) ensuring that the negative data does not interfere with the model's ability to learn from positive data, may be addressed by using randomly permuted English sentences as negative data. FIG. 3A also illustrates an example of negative training data 304 being provided to the language model 306. The negative training data 304 and the positive training data 302 may share the same vocabulary, ensuring that the language model 306 encounters familiar words and phrases, but they are arranged in a nonsensical, ungrammatical manner. For example, the sentence “All work and no play makes Jack a dull boy” might be randomly permuted into “play dull Jack makes and no boy all work a.” Such permutations preserve the vocabulary and basic token-level statistics of the positive data while appearing as nonsensical language that the model is discouraged from assigning high probabilities.

The negative training data 304 may be generated in various ways to ensure that it effectively challenges the language model without interfering with its ability to learn from the positive training data 302. One method may involve rearranging or permuting the words in the positive training data 302 to create a scrambled sequence for the negative training data 304. These permutations disrupt the grammatical and semantic structure of the original text, creating nonsensical sentences that the model is discouraged from assigning high probabilities to during training. The permutation of words may be random, allowing for a straightforward scrambling of the input sequence.

While random permutations are computationally simple, they may occasionally result in sequences where some words or substrings from the original positive training data 302 remain intact, reducing the effectiveness of the negative training data. To address this, permutations may be checked to ensure that the tokens are sufficiently scrambled. For example, algorithms can be used to verify that no substrings from the original positive training data 302 remain together in the negative training data 304. This ensures that the scrambled sequence does not contain adjacent words or phrases that resemble the original text. For example, in the sentence “All work and no play makes Jack a dull boy,” the method may ensure that common substrings such as “no play” or “Jack a” do not appear intact in the scrambled sequence.

Another approach involves varying the way tokens are defined during the permutation process. Instead of treating individual words as tokens, larger units such as 2-grams or 3-grams (pairs or triplets of words) may be used. For example, the phrase “All work and no play” could be tokenized into non-overlapping 2-grams like “All work,” “and no,” and “play makes.” These n-grams can then be treated as single units and scrambled to form a negative training sequence, such as “dull boy and no Jack a all work play makes” as illustrated in the negative training data 308 illustrated in FIG. 3B. Similarly, 3-grams like “All work and” or “no play makes” may be permuted to generate negative training data 308. Using larger token units may preserve some contextual relationships within the scrambled sequence while still ensuring that the overall structure remains nonsensical.

These different methods of generating negative training data-random permutation, validated scrambling to eliminate residual structure, and varying token definitions with n-grams-provide flexibility in tailoring the negative data to the specific needs of the training process. By experimenting with different scrambling techniques and tokenization schemes, the negative training data can be optimized to effectively prevent the model from learning undesirable shortcuts while still reinforcing its ability to focus on meaningful linguistic patterns in the positive data.

Each training session may include both the positive training data 302 and a unique permutation of the positive training data 302 as the negative training data 308. These two inputs may be processed together within the same training sequence to ensure that the language model simultaneously learns to assign high probabilities to well-formed, grammatical text while assigning low probabilities to nonsensical, ungrammatical text. During the training process, the positive training data 302 may be used to guide the language model 306 in learning to correctly predict and assign high probabilities to grammatical text. In parallel, a unique permutation of this sentence represented by the negative training data 308 may serve as a counterexample, challenging the model to assign low probabilities to ungrammatical or nonsensical inputs. The permutation is typically unique for each training session to ensure that the model is exposed to a diverse range of negative examples, preventing it from overfitting to specific patterns in the negative data.

In some embodiments, both the positive training data 302 and the negative training data 308 may be fed into the language model during the same training iteration. The model processes these inputs simultaneously, applying separate classifiers to each word or token in both sequences. For the positive data, the model's objective is to maximize the likelihood of the correct tokens. For the negative data, the model is trained to minimize the likelihood of the scrambled tokens, effectively discouraging it from learning shortcuts or adopting the identity function as a prediction strategy.

Therefore, FIGS. 3A-3B illustrate two individual training input pairs that may be provided to the language model 306. With each training iteration, the positive training data 302 may be permuted to generate a new, unique, scrambled version to use as the negative training data 308. Some embodiments may test each iteration of the negative training data 308 to ensure that it is sufficiently different from the positive training data 302 and/or other previous versions of the negative training data 308. Any number of training iterations may be used until the probabilities generated for the positive/negative training data are sufficient. However, experimental data shows that learning from all tokens in the positive training data 302 and using a permutation for the negative training data 308 takes far fewer training iterations than learning from individual tokens in masked data inputs.

The method 200 may further include training the language model using the positive training data and the negative training data (206). Generally, training the language model may include adjusting parameters of the language model to increase a probability associated with the positive training data and to decrease a probability associated with the negative training data. In anti-modeling, the goal may be to train a model to have high-likelihood on the data, but subject to the constraint that it is dissimilar to an anti-model that has also been previously fit on that data. Thus, the anti-model may be designed to capture spurious features of the data that the actual model should not learn. In practice this can be implemented by generating negative data from the anti-model and then training the actual model to have high likelihood on the positive data, and a low-likelihood on the negative data (that comes from the anti-model). The unlikelihood objective function may be written as:

$${\prod }_{x ∈ D} p ( x \vert W ) {( {\prod }_{\overline{x} ∈ \overline{D}} 1 - p ( \overline{x} \vert W ) )}^{α} \qquad ( 1 )$$

where D is the positive data that the model is being fit to, and D is the negative data that corresponds to the negative data that is being “unlearned” by the model, and Ware the weights that are learned during the training process. The hyperparameter a may control how aggressively the negative data unlearned.

The objective function in equation (1) mathematically maximizes the likelihood of predicting the positive training data while also maximizing one minus the likelihood of predicting the negative training data. Given the inexorable tension between the positive training data 902 and the negative training data 904, the hyperparameter a governs how to balance the relative contributions from these two data sets. The higher the value for the hyperparameter a is set, the more the contribution of the negative training data is weighed in equation (1). Without the hyperparameter, the contribution of the positive training data may tend to dominate the contribution of the negative training data. The hyperparameter solves this problem by allowing the experimental manipulation of the emphasis of the expression related to the negative training data until the contributions of each set of training data yield an optimal result.

The objective function of equation (1) may be implemented and minimized in existing auto-diff frameworks like PyTorch or Tensor Flow by minimizing it in log form. For gradient-taking expedience, it may be desirable in this case to work in log space. However, equation (1) is mathematically inconvenient in log space, for if an attempt is made to take the logarithm, it is immediately complicated by the one-minus-likelihood term for the negative training data. This makes it very difficult to apply an SGD on a per-input level. However, if the definitions of the maximum likelihood expressed in equation (1) are first expanded over all sequences in the positive training data, the first term just becomes the usual cross-entropy loss, while the second term becomes:

$$- α {\sum }_{{\overline{x}}_{i} ∈ \overline{x}} log ( 1 - exp ( - ℓ ( W , {\overline{x}}_{i} ) ) ) \qquad ( 2 )$$

where x̅ᵢ∈x̅ may be a token in the sequence x̅ and ( [symbol] (W, x̅ᵢ)) may be the amount of cross entropy loss that token contributes to the total loss.

The goal of training is to ensure that the negative training data prevents the model from cheating while not interfering significantly with the model's ability to learn the positive training data. As an example, for positive data x=“All work and no play makes Jack a dull boy,” a possible sample from the anti-model generating the negative data x=q(x) may be x̅=“work boy All dull a All makes play no and.” Equation (1) may therefore be used to simultaneously model token sequences that look like x and model the negative sequences that look like x. Since the data is permuted, the anti-model q(x) may have the following form:

$$q ( x ) = \frac{1}{\vert \overline{D} \vert} [ x ∈ \overline{D} ] \qquad ( 3 )$$

where D̅ may be the set of all permutations of all sentences in the positive dataset D.

This approach not only increases data efficiency by enabling the model to learn from every word in the sentence, but it also brings the computational cost of training closer to that of traditional masked language models. For example, a lightweight version of BERT with 8 heads, 4 layers, 320 hidden units, and a 10,000-token vocabulary can achieve comparable computational efficiency when training in an unmasked setting using the methods described herein. By eliminating the need to repeatedly mask and process individual tokens, the unmasked language model optimizes training time while maintaining the ability to learn from all available data in the input sequence.

It should be appreciated that the specific steps illustrated in FIG. 2 provide particular methods of training a language model using negative data according to various embodiments. Other sequences of steps may also be performed according to alternative embodiments. For example, alternative embodiments may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

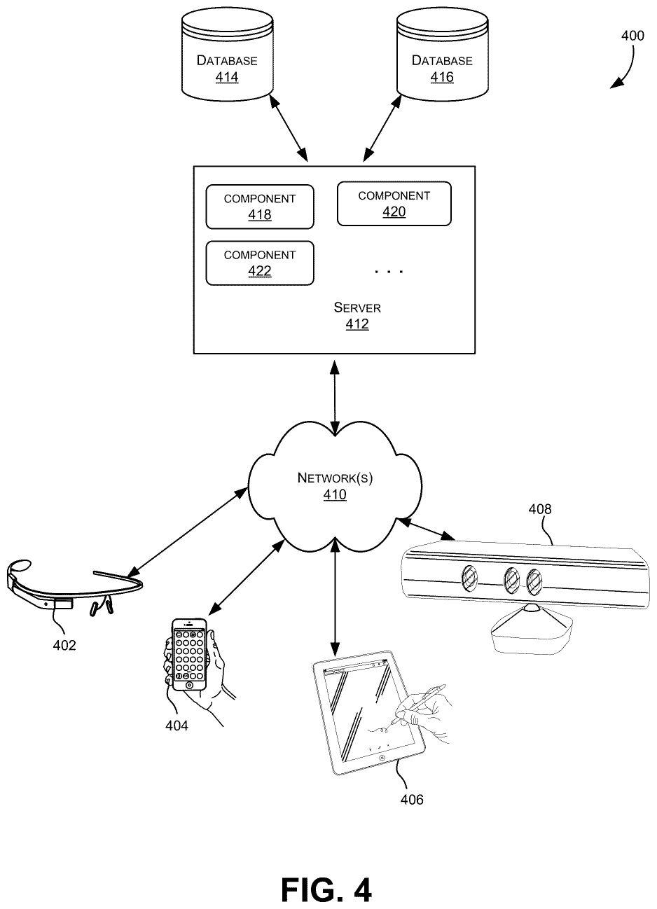

FIG. 4 depicts a simplified diagram of a distributed system 400 for implementing one of the embodiments. In the illustrated embodiment, distributed system 400 includes one or more client computing devices 402, 404, 406, and 408, which are configured to execute and operate a client application such as a web browser, proprietary client (e.g., Oracle Forms), or the like over one or more network(s) 410. Server 412 may be communicatively coupled with remote client computing devices 402, 404, 406, and 408 via network 410.

In various embodiments, server 412 may be adapted to run one or more services or software applications provided by one or more of the components of the system. In some embodiments, these services may be offered as web-based or cloud services or under a Software as a Service (SaaS) model to the users of client computing devices 402, 404, 406, and/or 408. Users operating client computing devices 402, 404, 406, and/or 408 may in turn utilize one or more client applications to interact with server 412 to utilize the services provided by these components.

In the configuration depicted in the figure, the software components 418, 420 and 422 of system 400 are shown as being implemented on server 412. In other embodiments, one or more of the components of system 400 and/or the services provided by these components may also be implemented by one or more of the client computing devices 402, 404, 406, and/or 408. Users operating the client computing devices may then utilize one or more client applications to use the services provided by these components. These components may be implemented in hardware, firmware, software, or combinations thereof. It should be appreciated that various different system configurations are possible, which may be different from distributed system 400. The embodiment shown in the figure is thus one example of a distributed system for implementing an embodiment system and is not intended to be limiting.

Client computing devices 402, 404, 406, and/or 408 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 402, 404, 406, and 408 may be any other electronic device, such as a thin-client computer, an Internet-enabled gaming system (e.g., a Microsoft Xbox gaming console with or without a Kinect® gesture input device), and/or a personal messaging device, capable of communicating over network(s) 410.

Although exemplary distributed system 400 is shown with four client computing devices, any number of client computing devices may be supported. Other devices, such as devices with sensors, etc., may interact with server 412.

Network(s) 410 in distributed system 400 may be any type of network that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 410 can be a local area network (LAN), such as one based on Ethernet, Token-Ring and/or the like. Network(s) 410 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 412 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 412 may be adapted to run one or more services or software applications described in the foregoing disclosure. For example, server 412 may correspond to a server for performing processing described above according to an embodiment of the present disclosure.

Server 412 may run an operating system including any of those discussed above, as well as any commercially available server operating system. Server 412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 412 may include one or more applications to analyze and consolidate data feeds and/or event updates received from users of client computing devices 402, 404, 406, and 408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 412 may also include one or more applications to display the data feeds and/or real-time events via one or more display devices of client computing devices 402, 404, 406, and 408.

Distributed system 400 may also include one or more databases 414 and 416. Databases 414 and 416 may reside in a variety of locations. By way of example, one or more of databases 414 and 416 may reside on a non-transitory storage medium local to (and/or resident in) server 412. Alternatively, databases 414 and 416 may be remote from server 412 and in communication with server 412 via a network-based or dedicated connection. In one set of embodiments, databases 414 and 416 may reside in a storage-area network (SAN). Similarly, any necessary files for performing the functions attributed to server 412 may be stored locally on server 412 and/or remotely, as appropriate. In one set of embodiments, databases 414 and 416 may include relational databases, such as databases provided by Oracle, that are adapted to store, update, and retrieve data in response to SQL-formatted commands.

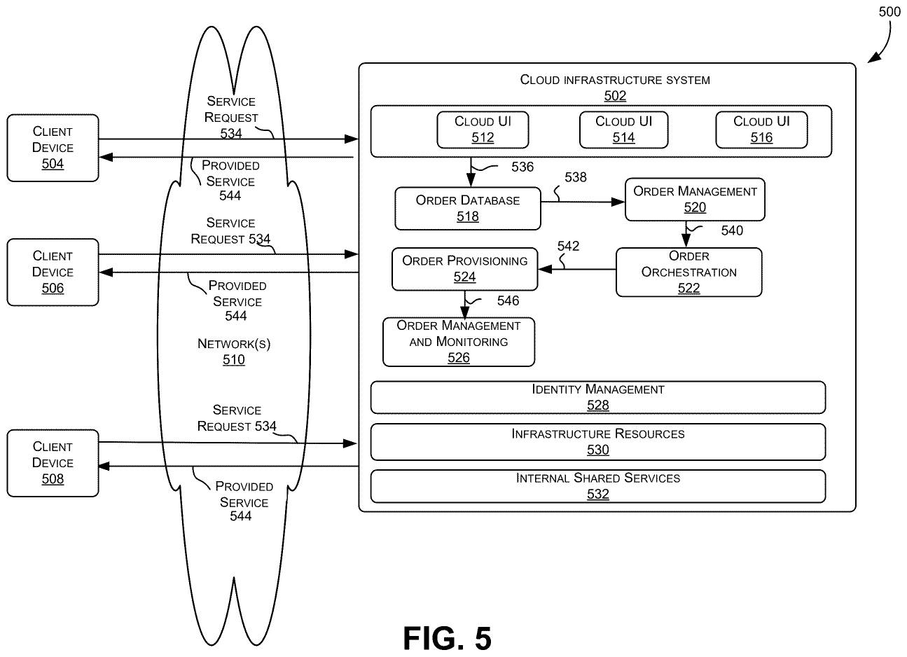

FIG. 5 is a simplified block diagram of one or more components of a system environment 500 by which services provided by one or more components of an embodiment system may be offered as cloud services, in accordance with an embodiment of the present disclosure. In the illustrated embodiment, system environment 500 includes one or more client computing devices 504, 506, and 508 that may be used by users to interact with a cloud infrastructure system 502 that provides cloud services. The client computing devices may be configured to operate a client application such as a web browser, a proprietary client application (e.g., Oracle Forms), or some other application, which may be used by a user of the client computing device to interact with cloud infrastructure system 502 to use services provided by cloud infrastructure system 502.

It should be appreciated that cloud infrastructure system 502 depicted in the figure may have other components than those depicted. Further, the system shown in the figure is only one example of a cloud infrastructure system that may incorporate some embodiments. In some other embodiments, cloud infrastructure system 502 may have more or fewer components than shown in the figure, may combine two or more components, or may have a different configuration or arrangement of components.

Client computing devices 504, 506, and 508 may be devices similar to those described above for 402, 404, 406, and 408.

Although exemplary system environment 500 is shown with three client computing devices, any number of client computing devices may be supported. Other devices such as devices with sensors, etc. may interact with cloud infrastructure system 502.

Network(s) 510 may facilitate communications and exchange of data between clients 504, 506, and 508 and cloud infrastructure system 502. Each network may be any type of network that can support data communications using any of a variety of commercially-available protocols, including those described above for network(s) 410.

Cloud infrastructure system 502 may comprise one or more computers and/or servers that may include those described above for server 412.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 502 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 502 may be adapted to automatically provision, manage and track a customer's subscription to services offered by cloud infrastructure system 502. Cloud infrastructure system 502 may provide the cloud services via different deployment models. For example, services may be provided under a public cloud model in which cloud infrastructure system 502 is owned by an organization selling cloud services (e.g., owned by Oracle) and the services are made available to the general public or different industry enterprises. As another example, services may be provided under a private cloud model in which cloud infrastructure system 502 is operated solely for a single organization and may provide services for one or more entities within the organization. The cloud services may also be provided under a community cloud model in which cloud infrastructure system 502 and the services provided by cloud infrastructure system 502 are shared by several organizations in a related community. The cloud services may also be provided under a hybrid cloud model, which is a combination of two or more different models.

In some embodiments, the services provided by cloud infrastructure system 502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 502. Cloud infrastructure system 502 then performs processing to provide the services in the customer's subscription order.

In some embodiments, the services provided by cloud infrastructure system 502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 502 may also include infrastructure resources 530 for providing the resources used to provide various services to customers of the cloud infrastructure system. In one embodiment, infrastructure resources 530 may include pre-integrated and optimized combinations of hardware, such as servers, storage, and networking resources to execute the services provided by the PaaS platform and the SaaS platform.

In some embodiments, resources in cloud infrastructure system 502 may be shared by multiple users and dynamically re-allocated per demand. Additionally, resources may be allocated to users in different time zones. For example, cloud infrastructure system 530 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 532 may be provided that are shared by different components or modules of cloud infrastructure system 502 and by the services provided by cloud infrastructure system 502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 502, and the like.

In one embodiment, as depicted in the figure, cloud management functionality may be provided by one or more modules, such as an order management module 520, an order orchestration module 522, an order provisioning module 524, an order management and monitoring module 526, and an identity management module 528. These modules may include or be provided using one or more computers and/or servers, which may be general purpose computers, specialized server computers, server farms, server clusters, or any other appropriate arrangement and/or combination.

In exemplary operation 534, a customer using a client device, such as client device 504, 506 or 508, may interact with cloud infrastructure system 502 by requesting one or more services provided by cloud infrastructure system 502 and placing an order for a subscription for one or more services offered by cloud infrastructure system 502. In certain embodiments, the customer may access a cloud User Interface (UI), cloud UI 512, cloud UI 514 and/or cloud UI 516 and place a subscription order via these UIs. The order information received by cloud infrastructure system 502 in response to the customer placing an order may include information identifying the customer and one or more services offered by the cloud infrastructure system 502 that the customer intends to subscribe to.

After an order has been placed by the customer, the order information is received via the cloud UIs, 512, 514 and/or 516.

At operation 536, the order is stored in order database 518. Order database 518 can be one of several databases operated by cloud infrastructure system 518 and operated in conjunction with other system elements.

At operation 538, the order information is forwarded to an order management module 520. In some instances, order management module 520 may be configured to perform billing and accounting functions related to the order, such as verifying the order, and upon verification, booking the order.

At operation 540, information regarding the order is communicated to an order orchestration module 522. Order orchestration module 522 may utilize the order information to orchestrate the provisioning of services and resources for the order placed by the customer. In some instances, order orchestration module 522 may orchestrate the provisioning of resources to support the subscribed services using the services of order provisioning module 524.

In certain embodiments, order orchestration module 522 enables the management of business processes associated with each order and applies business logic to determine whether an order should proceed to provisioning. At operation 542, upon receiving an order for a new subscription, order orchestration module 522 sends a request to order provisioning module 524 to allocate resources and configure those resources needed to fulfill the subscription order. Order provisioning module 524 enables the allocation of resources for the services ordered by the customer. Order provisioning module 524 provides a level of abstraction between the cloud services provided by cloud infrastructure system 500 and the physical implementation layer that is used to provision the resources for providing the requested services. Order orchestration module 522 may thus be isolated from implementation details, such as whether or not services and resources are actually provisioned on the fly or pre-provisioned and only allocated/assigned upon request.

At operation 544, once the services and resources are provisioned, a notification of the provided service may be sent to customers on client devices 504, 506 and/or 508 by order provisioning module 524 of cloud infrastructure system 502.

At operation 546, the customer's subscription order may be managed and tracked by an order management and monitoring module 526. In some instances, order management and monitoring module 526 may be configured to collect usage statistics for the services in the subscription order, such as the amount of storage used, the amount data transferred, the number of users, and the amount of system up time and system down time.

In certain embodiments, cloud infrastructure system 500 may include an identity management module 528. Identity management module 528 may be configured to provide identity services, such as access management and authorization services in cloud infrastructure system 500. In some embodiments, identity management module 528 may control information about customers who wish to utilize the services provided by cloud infrastructure system 502. Such information can include information that authenticates the identities of such customers and information that describes which actions those customers are authorized to perform relative to various system resources (e.g., files, directories, applications, communication ports, memory segments, etc.) Identity management module 528 may also include the management of descriptive information about each customer and about how and by whom that descriptive information can be accessed and modified.

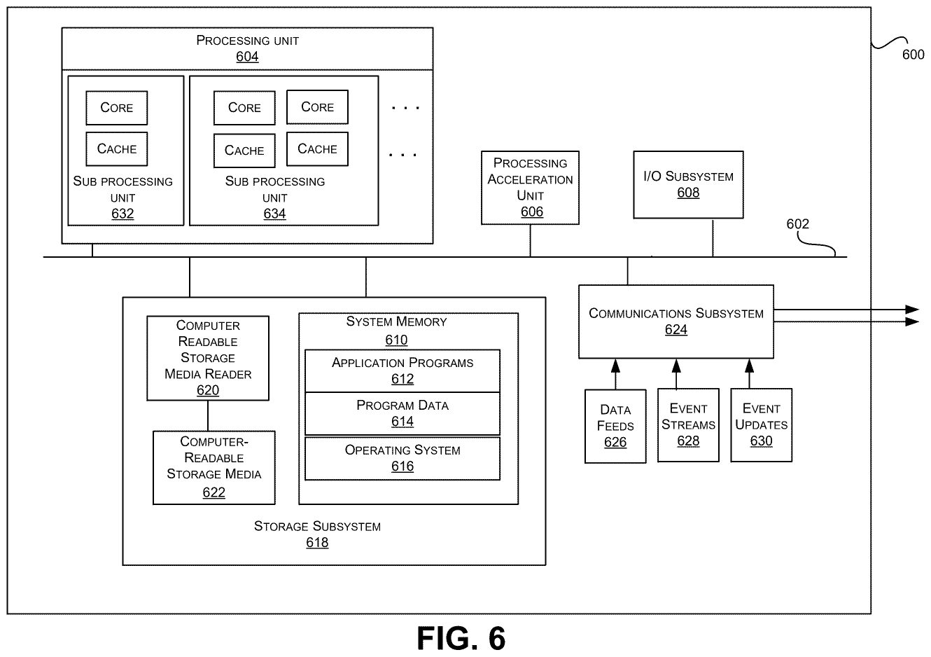

FIG. 6 illustrates an exemplary computer system 600, in which various embodiments may be implemented. The system 600 may be used to implement any of the computer systems described above. As shown in the figure, computer system 600 includes a processing unit 604 that communicates with a number of peripheral subsystems via a bus subsystem 602. These peripheral subsystems may include a processing acceleration unit 606, an I/O subsystem 608, a storage subsystem 618 and a communications subsystem 624. Storage subsystem 618 includes tangible computer-readable storage media 622 and a system memory 610.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which can be implemented as one or more integrated circuits (e.g., a conventional microprocessor or microcontroller), controls the operation of computer system 600. One or more processors may be included in processing unit 604. These processors may include single core or multicore processors. In certain embodiments, processing unit 604 may be implemented as one or more independent processing units 632 and/or 634 with single or multicore processors included in each processing unit. In other embodiments, processing unit 604 may also be implemented as a quad-core processing unit formed by integrating two dual-core processors into a single chip.

In various embodiments, processing unit 604 can execute a variety of programs in response to program code and can maintain multiple concurrently executing programs or processes. At any given time, some or all of the program code to be executed can be resident in processor(s) 604 and/or in storage subsystem 618. Through suitable programming, processor(s) 604 can provide various functionalities described above. Computer system 600 may additionally include a processing acceleration unit 606, which can include a digital signal processor (DSP), a special-purpose processor, and/or the like.

I/O subsystem 608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 600 may comprise a storage subsystem 618 that comprises software elements, shown as being currently located within a system memory 610. System memory 610 may store program instructions that are loadable and executable on processing unit 604, as well as data generated during the execution of these programs.

Depending on the configuration and type of computer system 600, system memory 610 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 604. In some implementations, system memory 610 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the ROM. By way of example, and not limitation, system memory 610 also illustrates application programs 612, which may include client applications, Web browsers, mid-tier applications, relational database management systems (RDBMS), etc., program data 614, and an operating system 616. By way of example, operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 618 may also provide a tangible computer-readable storage medium for storing the basic programming and data constructs that provide the functionality of some embodiments. Software (programs, code modules, instructions) that when executed by a processor provide the functionality described above may be stored in storage subsystem 618. These software modules or instructions may be executed by processing unit 604. Storage subsystem 618 may also provide a repository for storing data used in accordance with some embodiments.

Storage subsystem 600 may also include a computer-readable storage media reader 620 that can further be connected to computer-readable storage media 622. Together and, optionally, in combination with system memory 610, computer-readable storage media 622 may comprehensively represent remote, local, fixed, and/or removable storage devices plus storage media for temporarily and/or more permanently containing, storing, transmitting, and retrieving computer-readable information.

Computer-readable storage media 622 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 600.

By way of example, computer-readable storage media 622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to connect to one or more devices via the Internet. In some embodiments communications subsystem 624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 624 can provide wired network connectivity (e.g., Ethernet) in addition to or instead of a wireless interface.

In some embodiments, communications subsystem 624 may also receive input communication in the form of structured and/or unstructured data feeds 626, event streams 628, event updates 630, and the like on behalf of one or more users who may use computer system 600.

By way of example, communications subsystem 624 may be configured to receive data feeds 626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 624 may also be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 624 may also be configured to output the structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method for training language models, the method comprising:
providing a sequence of tokens representing positive training data;
permuting the sequence of tokens to represent negative training data; and
training a language model using the positive training data and the negative training data, wherein training the language model comprises adjusting parameters of the language model to increase a probability associated with the positive training data and to decrease a probability associated with the negative training data.

2. The method of claim 1, wherein training the language model comprises using a likelihood function, wherein the likelihood function maximizes a probability of the language model predicting the positive training data.

3. The method of claim 1, wherein training the language model comprises using a likelihood function, wherein the likelihood function minimizes a probability of the language model predicting the negative training data.

4. The method of claim 1, wherein minimizing the probability of the language model predicting the negative training data comprises:
maximizing 1 minus the probability of the language model predicting the negative training data.

5. The method of claim 4, wherein the likelihood function optimizes a plurality of weights.

6. The method of claim 1, wherein the negative training data comprises a permutation of the positive training data, the permutation being a rearrangement of tokens within the positive training data.

7. The method of claim 6, wherein the permutation is random, such that the tokens of the positive training data are randomly rearranged to form the negative training data.

8. The method of claim 6, wherein the permutation is validated to ensure that no substrings of the positive training data remain intact in the negative training data.

9. A non-transitory computer-readable medium comprising instructions that, when executed by one or more processors, cause the one or more processors to perform operations comprising:
providing a sequence of tokens representing positive training data;
permuting the sequence of tokens to represent negative training data; and
training a language model using the positive training data and the negative training data, wherein training the language model comprises adjusting parameters of the language model to increase a probability associated with the positive training data and to decrease a probability associated with the negative training data.

10. The non-transitory computer-readable medium of claim 9, wherein the negative training data is generated by tokenizing the positive training data into n-grams, and the n-grams are permuted to form the negative training data.

11. The non-transitory computer-readable medium of claim 9, wherein the operations further comprise generating the negative training data using an anti-model, wherein the anti-model is trained to generate un-grammatical features based on the positive training data.

12. The non-transitory computer-readable medium of claim 9, wherein the operations further comprise performing training iterations, wherein each of the training iterations comprises providing a unique permutation of the positive training data as the negative training data.

13. The non-transitory computer-readable medium of claim 9, wherein training the language model comprises using a single forward pass to process both the positive training data and the negative training data together.

14. The non-transitory computer-readable medium of claim 9, wherein the positive training data is obtained from publicly available corpora.

15. A system comprising:
one or more processors; and
one or more memory devices comprising instructions that, when executed by the one or more processors, cause the one or more processors to perform operations comprising:
providing a sequence of tokens representing positive training data;
permuting the sequence of tokens to represent negative training data; and
training a language model using the positive training data and the negative training data, wherein training the language model comprises adjusting parameters of the language model to increase a probability associated with the positive training data and to decrease a probability associated with the negative training data.

16. The system of claim 15, wherein the language model comprises a masked model.

17. The system of claim 15, wherein the language model comprises a Bidirectional Encoder Representations from Transformers model.

18. The system of claim 15, wherein the negative training data is generated by applying random permutations to sentences in the positive training data, the operations further comprising verifying that the negative training data does not resemble natural language constructs.

19. The system of claim 15, wherein the negative training data is a same length as the positive training data, and tokens in the negative training data are all found in the positive training data.

20. The system of claim 15, wherein training the language model further comprises using stochastic gradient descent to iteratively adjust internal parameters of the language model based on the positive training data and the negative training data.
